(19) United States
(12) Patent Application Publication
(10) Pub. No.: US 2024/0409451 A1
(43) Pub. Date: Dec. 12, 2024

(54) Privacy Glass Without Selenium

(71) Applicant: Vitro Flat Glass LLC, Cheswick, PA (US)

(72) Inventors: José Guadalupe Cid-Aguilar, Cheswick, PA (US); Adam D. Polcyn, Cheswick, PA (US)

(21) Appl. No.: 18/737,035

(22) Filed: Jun. 7, 2024

Related U.S. Application Data
(60) Provisional application No. 63/471,780, filed on Jun. 8, 2023.

(51) Int. Cl. C03C 3/087; C03C 4/08

(52) U.S. Cl. CPC C03C 3/087; C03C 4/08

(57) ABSTRACT

The present invention relates to privacy glass and environmentally-friendly methods of making the same. In particular, the invention relates to privacy glass for use in vehicle windows, produced by environmentally-friendly float processes.

### CROSS-REFERENCE TO RELATED APPLICATIONS

This application claims priority to U.S. Provisional Patent Application No. 63/471,780, filed Jun. 8, 2023, the disclosure of which is hereby incorporated by reference in its entirety.

### BACKGROUND OF THE INVENTION

### Field of the Invention

The present invention relates to privacy glass and environmentally-friendly methods of making the same. In particular, the invention relates to privacy glass for use in vehicle windows, produced by environmentally-friendly float processes.

### Description of the Related Art

Producing privacy glasses typically involves a process whereby significant quantities of Se are released into the atmosphere. Such emissions are dangerous to human health, and for this reason, are subject to federal regulations in the United States. Until now, privacy glasses produced without the use of Se generally resulted in very dark glass compositions which block most visible light. For example, U.S. Pat. No. 8,901,021 B2 to Shelestak et al. (“Shelestak”) teaches a glass composition comprising less than 0.0003 weight percent of Se and permitting a visible light transmittance of 15 percent or less. Of note, the glass composition of Shelestak is not compatible with the “float” process, which involves cooling glass after it exits a furnace by floating it on a pool of molten tin.

### SUMMARY OF THE INVENTION

The invention relates to a glass that, in one embodiment, is substantially free of Se and SnO₂ having a suitable amount of cobalt oxide (CoO) in the glass, wherein the glass has a visible light transmission (“T_{LA}”) of greater than 0 percent and equal to or less than 21 percent at a glass thickness of 4.1 mm as CIE standard Ilum “A” wavelengths 380 nm to 780 nm. Alternatively, in another embodiment, the invention relates to a glass that contains a suitable amount of SnO₂ as well as having a suitable amount of cobalt oxide (CoO) in the glass, wherein the glass has a T_{LA} of greater than 0 percent and equal to or less than 21 percent at a glass thickness of 4.1 mm as CIE standard Ilum “A” wavelengths 380 nm to 780 nm.

The invention further relates to a method of making a glass by, among other things, providing a glass batch that, in one embodiment, is substantially free of Se and SnO₂ having a suitable amount of CoO in the glass batch to yield a glass that has a T_{LA} of greater than 0 percent and equal to or less than 21 percent at a glass thickness of 4.1 mm as CIE standard Ilum “A” wavelengths 380 nm to 780 nm. Alternatively, in another embodiment, the invention further relates to a method of making a glass by, among other things, providing a glass batch that contains a suitable amount of SnO₂ as well as having a suitable amount of cobalt oxide (CoO) in the glass batch to yield a glass that has a T_{LA} of greater than 0 percent and equal to or less than 21 percent at a glass thickness of 4.1 mm as CIE standard Ilum “A” wavelengths 380 nm to 780 nm.

Further non-limiting embodiments or aspects are set forth and described in the following clauses.

Clause 1: A glass comprising: 66-75 weight percent SiO₂; 10-20 weight percent Na₂O; 5-15 weight percent CaO; 0-5 weight percent MgO; 0-5 weight percent Al₂O₃; 0-3 weight percent K₂O; 0.04-0.09 weight percent SO₃; and 0.29-0.62 weight percent total iron expressed as Fe₂O₃, wherein the glass is substantially free of Se, and wherein the glass has a T_{LA} of greater than 0 percent and equal to or less than 21 percent at a glass thickness of 4.1 mm as CIE standard Ilum “A” wavelengths 380 nm to 780 nm.

Clause 2: The glass of clause 1, further comprising a redox ratio of at least 0.61 and at most 0.84.

Clause 3: The glass of any of clauses 1-2, further comprising a redox ratio of at least 0.63 and at most 0.82.

Clause 4: The glass of any of clauses 1-3, further comprising 0.026-0.057 weight percent CoO.

Clause 5: The glass of any of clauses 1-4, further comprising 0.027-0.056 weight percent CoO.

Clause 6: The glass of any of clauses 1-5, comprising 0.20-0.51 weight percent FeO.

Clause 7: The glass of any of clauses 1-6, wherein the glass is substantially free of SnO₂.

Clause 8: The glass of any of clauses 1-7, wherein the glass has a T_{UV} of less than 47, less than 20, or even less than 10 and/or a Te of less than 23, less than 20, or even less than 16.

Clause 9: A method of making a glass using a conventional float non-vacuum glass system, comprising: melting a glass batch to provide a pool of molten glass; flowing the pool of molten glass onto the molten tin bath; moving the molten glass on the surface of the molten tin bath, while controllably cooling the molten glass and applying forces to the molten glass to provide a glass of a desired thickness; and removing the glass from the molten tin bath, wherein the glass comprises: 66-75 weight percent SiO₂; 10-20 weight percent Na₂O; 5-15 weight percent CaO; 0-5 weight percent MgO; 0-5 weight percent Al₂O₃; 0-3 weight percent K₂O; 0.04-0.09 weight percent SO₃; and 0.29-0.62 weight percent total iron expressed as Fe₂O₃, wherein the glass is substantially free of Se, and wherein the glass has a T_{LA} of greater than 0 percent and equal to or less than 21 percent at a glass thickness of 4.1 mm as CIE standard Ilum “A” wavelengths 380 nm to 780 nm.

Clause 10: The method of clause 9, the glass further comprising a redox ratio of at least 0.61 and at most 0.84.

Clause 11: The method of any of clauses 9-10, the glass further comprising a redox ratio of at least 0.63 and at most 0.82.

Clause 12: The method of any of clauses 9-11, the glass further comprising 0.026-0.057 weight percent CoO.

Clause 13: The method of any of clauses 9-12, the glass further comprising 0.027-0.056 weight percent CoO.

Clause 14: The method of any of clauses 9-13, the glass further comprising 0.20-0.51 weight percent FeO.

Clause 15: The method of any of clauses 9-14, wherein the glass batch comprises 0.017-0.11 weight percent coal.

Clause 16: The method of any of clauses 9-15, wherein the glass batch comprises 0.11-0.37 weight percent pyrite (Fe₂S).

Clause 17: The method of any of clauses 9-16, wherein the glass batch, or the glass itself, is substantially free of SnO₂.

Clause 18: The method of any of clauses 9-17, wherein the glass has a T_{UV} of less than 47, less than 20, or even less than 10 and/or a Te of less than 23, less than 20, or even less than 16.

Clause 19: A glass comprising: 66-75 weight percent SiO₂; 10-20 weight percent Na₂O; 5-15 weight percent CaO; 0-5 weight percent MgO; 0-5 weight percent Al₂O₃; 0-3 weight percent K₂O; 0.043-0.081 weight percent SO₃; and 0.29-0.61 weight percent total iron expressed as Fe₂O₃, wherein the glass is substantially free of Se, and wherein the glass has a T_{LA} of greater than 0 percent and equal to or less than 21 percent at a glass thickness of 4.1 mm as CIE standard Ilum “A” wavelengths 380 nm to 780 nm.

Clause 20: The glass of clause 19, further comprising a redox ratio of at least 0.61 and at most 0.84.

Clause 21: The glass of any of clauses 19-20, further comprising a redox ratio of at least 0.63 and at most 0.82.

Clause 22: The glass of any of clauses 19-21, further comprising 0.027-0.056 weight percent CoO.

Clause 23: The glass of any of clauses 19-22, further comprising 0.027-0.056 weight percent CoO.

Clause 24: The glass of any of clauses 19-23, comprising 0.21-0.50 weight percent FeO.

Clause 25: The glass of any of clauses 19-24, wherein the glass is substantially free of SnO₂.

Clause 26: The glass of any of clauses 19-25, wherein the glass has a T_{UV} of less than 47, less than 20, or even less than 10 and/or a Te of less than 23, less than 20, or even less than 16.

Clause 27: A method of making a glass using a conventional float non-vacuum glass system, comprising: melting a glass batch to provide a pool of molten glass; flowing the pool of molten glass onto the molten tin bath; moving the molten glass on the surface of the molten tin bath, while controllably cooling the molten glass and applying forces to the molten glass to provide a glass of a desired thickness; and removing the glass from the molten tin bath, wherein the glass comprises: 66-75 weight percent SiO₂; 10-20 weight percent Na₂O; 5-15 weight percent CaO; 0-5 weight percent MgO; 0-5 weight percent Al₂O₃; 0-3 weight percent K₂O; 0.043-0.081 weight percent SO₃; and 0.29-0.61 weight percent total iron expressed as Fe₂O₃, wherein the glass is substantially free of Se, and wherein the glass has a T_{LA} of greater than 0 percent and equal to or less than 21 percent at a glass thickness of 4.1 mm as CIE standard Ilum “A” wavelengths 380 nm to 780 nm.

Clause 28: The method of clause 27, the glass further comprising a redox ratio of at least 0.61 and at most 0.84.

Clause 29: The method of any of clauses 27-28, the glass further comprising a redox ratio of at least 0.63 and at most 0.82.

Clause 30: The method of any of clauses 27-29, the glass further comprising 0.027-0.056 weight percent CoO.

Clause 31: The method of any of clauses 27-30, the glass further comprising 0.027-0.056 weight percent CoO.

Clause 32: The method of any of clauses 27-31, the glass further comprising 0.21-0.50 weight percent FeO.

Clause 33: The method of any of clauses 27-32, wherein the glass batch comprises 0.018-0.11 weight percent coal.

Clause 34: The method of any of clauses 27-33, wherein the glass batch comprises 0.11-0.36 weight percent Fe₂S.

Clause 35: The method of any of clauses 27-34, wherein the glass batch, or the glass itself, is substantially free of SnO₂.

Clause 36: The method of any of clauses 27-35, wherein the glass has a T_{UV} of less than 47, less than 20, or even less than 10 and/or a Te of less than 23, less than 20, or even less than 16.

Clause 37: A glass comprising: 66-75 weight percent SiO₂; 10-20 weight percent Na₂O; 5-15 weight percent CaO; 0-5 weight percent MgO; 0-5 weight percent Al₂O₃; 0-3 weight percent K₂O; 0.044-0.080 weight percent SO₃; and 0.30-0.60 weight percent total iron expressed as Fe₂O₃, wherein the glass is substantially free of Se, and wherein the glass has a T_{LA} of greater than 0 percent and equal to or less than 21 percent at a glass thickness of 4.1 mm as CIE standard Ilum “A” wavelengths 380 nm to 780 nm.

Clause 38: The glass of clause 37, further comprising a redox ratio of at least 0.63 and at most 0.82.

Clause 39: The glass of any of clauses 37-38, further comprising 0.027-0.056 weight percent CoO.

Clause 40: The glass of any of clauses 37-39, comprising 0.21-0.50 weight percent FeO.

Clause 41: The glass of any of clauses 37-40, wherein the glass is substantially free of SnO₂.

Clause 42: The glass of any of clauses 37-41, wherein the glass has a T_{UV} of less than 47, less than 20, or even less than 10 and/or a Te of less than 23, less than 20, or even less than 16.

Clause 43: A method of making a glass using a conventional float non-vacuum glass system, comprising: melting a glass batch to provide a pool of molten glass; flowing the pool of molten glass onto the molten tin bath; moving the molten glass on the surface of the molten tin bath, while controllably cooling the molten glass and applying forces to the molten glass to provide a glass of a desired thickness; and removing the glass from the molten tin bath, wherein the glass comprises: 66-75 weight percent SiO₂; 10-20 weight percent Na₂O; 5-15 weight percent CaO; 0-5 weight percent MgO; 0-5 weight percent Al₂O₃; 0-3 weight percent K₂O; 0.044-0.080 weight percent SO₃; and 0.30-0.60 weight percent total iron expressed as Fe₂O₃, wherein the glass is substantially free of Se, and wherein the glass has a T_{LA} of greater than 0 percent and equal to or less than 21 percent at a glass thickness of 4.1 mm as CIE standard Ilum “A” wavelengths 380 nm to 780 nm.

Clause 44: The method of clause 43, the glass further comprising a redox ratio of at least 0.63 and at most 0.82.

Clause 45: The method of any of clauses 43-44, the glass further comprising 0.027-0.056 weight percent CoO.

Clause 46: The method of any of clauses 43-45, the glass further comprising 0.21-0.50 weight percent FeO.

Clause 47: The method of any of clauses 43-46, wherein the glass batch comprises 0.019-0.10 weight percent coal.

Clause 48: The method of any of clauses 43-47, wherein the glass batch comprises 0.12-0.36 weight percent Fe₂S.

Clause 49: The method of any of clauses 43-48, wherein the glass batch, or the glass itself, is substantially free of SnO₂.

Clause 50: The method of any of clauses 27-35, wherein the glass has a T_{UV} of less than 47, less than 20, or even less than 10 and/or a Te of less than 23, less than 20, or even less than 16.

### DETAILED DESCRIPTION OF THE INVENTION

Unless otherwise indicated, all numbers expressing dimensions, physical characteristics, quantities of ingredients, reaction conditions, and so forth used in the specification and claims are to be understood as being modified in all instances by the term “about”. At the very least, and not as an attempt to limit the application of the doctrine of equivalents to the scope of the claims, each numerical parameter should be construed in light of the number of reported significant digits and by applying ordinary rounding techniques. Moreover, all ranges disclosed herein include the beginning and ending range values, and to encompass any and all subranges subsumed therein. For example, a stated range of “1 to 10” should be considered to include any and all subranges between (and inclusive of) the minimum value of 1 and the maximum value of 10.

Any reference to composition amounts, unless otherwise specified, is “by weight percent” based on the total weight of the final glass composition. The “total iron” content of the glass compositions disclosed herein is expressed in terms of Fe₂O₃ in accordance with standard analytical practice, regardless of the form actually present. Likewise, the amount of iron in the ferrous state is reported as FeO, even though it may not actually be present in the glass as FeO. The terms “redox”, “redox ratio”, or “iron redox ratio” mean the amount of iron in the ferrous state (expressed as FeO) divided by the amount of total iron (expressed as Fe₂O₃). The “sulfur” content of the glass compositions disclosed herein is expressed in terms of SO₃ in accordance with standard analytical practices, regardless of the form actually present.

As used herein, “substantially free of selenium” or “substantially free of Se” means that there is no amount of Se in the glass intentionally added in the glass, but that there may be a trace amount (i.e. 0 parts per million (ppm) to 2 ppm) of Se.

As used herein, “substantially free of tin oxide” or “substantially free of SnO₂” means that no tin oxide has been intentionally added to the composition. For example, “substantially free of tin oxide” or “substantially free of SnO₂” means that the batch ingredients do not contain any appreciable amount of tin oxide and any tin oxide present in a final glass product is the result of the float glass process.

As used herein, “visible transmittance” values are determined using the conventional CIE standard Illuminant A and 2-degree observer angle. Those skilled in the art will understand that properties such as visible transmittance can be calculated at an equivalent standard thickness, e.g., 5.5 millimeters (mm), even though the actual thickness of a measured glass sample is different than the standard thickness.

All documents, such as, but not limited to, issued patents and patent applications, referred to herein are to be considered to be incorporated by reference in their entireties.

Iron can be found in glass in two different oxidation states: iron in the ferrous state (Fe²⁺, expressed as ferrous oxide, FeO), and iron in the ferric state (Fe³⁺, expressed as ferric oxide, Fe₂O₃). Each ion, Fe²⁺ and Fe³⁺, confers different properties to the glass in which it is situated. Fe²⁺ has a broad and strong absorption band centered at 1050 nm, which results in decreased transmission of infrared radiation (T_{IR}). In addition, this band extends to the visible region, which results in decreased transmission of visible light and imparts a bluish coloration to the glass. Fe³⁺ has a strong absorption located in the ultraviolet region, which results in decreased transmission of ultraviolet radiation (T_{UV}). In addition, Fe³⁺ has two weak bands located in the visible light region between 420 and 440 nm, which results in a slightly decreased transmission of visible light and imparts a yellowish coloration to the glass.

The balance between ferrous and ferric oxide has a direct effect on the characteristics of the color and transmittance of the glass.

$$Iron Redox Ratio = \frac{{Fe}^{2 +} ( as weight percent FeO )}{Total Fe ( as weight percent {Fe}_{2} {O}_{3} )}$$

The term “iron redox ratio” means the amount of iron in the ferrous state (expressed as FeO) divided by the amount of total iron (expressed as Fe₂O₃). This means that the greater the amount of ferric ion (Fe³⁺) presented in the glass, the greater the absorption of ultraviolet radiation and the transmission of light will increase; as well as the yellowish hue; but, if the content of the ferrous ion (Fe²⁺) increases as a result of the chemical reduction of Fe₂O₃, the absorption of the infrared radiation will increase, but the ultraviolet radiation will decrease as well as the light transmission.

Fe³⁺(Yellow) [symbol] Fe²⁺(Blue) [Yellow+Blue=Green]

2Fe₂O₃ [symbol] 4FeO=O₂

The variation of the concentration of FeO in relation to Fe₂O₃ gives rise to a change of color in the glass. The displacement of the color can be modified from yellow through green and blue until reaching amber. From blue, the amber coloration in the glass is given by the formation of iron polysulfide under high redox conditions. The color changes in the following way (according to experimental results):
Yellow—Low redox (0.12)—High light transmission (High ferric ion)
Yellow-Green (0.16)
Green-Yellowish (0.20)
Green (0.25 typical green glass value)
Bluish Green (0.29)
Greenish Blue (0.35)
Blue (0.50)
Olive Green (0.60)
Champagne (0.65)
Amber—High redox (0.75)—Low light transmission (low ferric ion)

As will be appreciated by one of ordinary skill in the art, controlling redox of a glass composition is achieved by controlling the conditions under which the glass is made. Many such factors may affect redox. The concentration of reducing agents (such as carbon) and the concentration of oxidizing agents (such as sodium sulfate) may each affect redox. For example, sodium sulfate (Na₂SO₄) may be added as a raw material to the glass batch for bubble elimination, high temperature refinement, promotion of mass transport, dissolution of free silica at the surface of the glass, and lessening the number of solid inclusions. However, Na₂SO₄ has oxidizing properties, such that small amounts of carbon are usually added to the mixture in order to counteract undesired oxidation. Further, Na₂SO₄ is converted during the glass manufacturing process into SO₃, which has an inverse relationship with redox, while sulfur has as direct relationship with redox. Finally, melting conditions, such as varying oxygen excess and adjusting flame alignment during combustion in a furnace, may further affect redox.

As can now be appreciated, the invention is directed to a selenium-free privacy glass and methods for making therefor. The invention is not limited to the process of, and/or equipment for, practicing the invention to make glasses of the invention, and any of the glass making processes and/or equipment known in the art can be used in the practice of the invention.

In one aspect of the present invention, the present invention comprises a glass with a T_{LA} of less than 21 percent which is substantially free of Se and which comprises between 0.042-0.082 weight percent of SO₃, between 0.043-0.081 weight percent of SO₃, or even between 0.044-0.080 weight percent of SO₃. Unlike the privacy glasses of the prior art, sulfur is substituted for Se in the present invention without compromising the range of T_{LA} necessary to maintain the privacy characteristics of the glass.

In another aspect, the present invention further comprises between 0.0265-0.0563 weight percent CoO, between 0.0271-0.0557 weight percent CoO, or even between 0.0277-0.0551 weight percent CoO. The addition of CoO assists in neutralizing the color of the glass while simultaneously assisting in achieving a T_{LA} range of 0.5-21 percent.

In yet another aspect, the present invention comprises a method wherein the amount of coal in the glass batch is controlled to be between 0.017-0.102 weight percent, between 0.018-0.101 weight percent, or even between 0.019-0.10 weight percent coal.

According to the present invention, the following performance properties are measured as described below. The total solar ultraviolet transmittance (T_{UV}) is measured over the wavelength range of 300 nm to 400 nm, using the ISO 13837 standard. The visible light transmittance is measured using CIE standard illuminant “A” with a 2° observer (T_{LA}) over the wavelength range 380 nm to 780 nm. The solar direct transmittance (Te) is measured over the wavelength range of 300 nm to 2500 nm, using the ISO 13837 standard. The total solar infrared transmittance (T_{IR}) is measured over the wavelength range of 800 nm to 2500 nm, using the ISO 13837 standard. The total solar transmittance (T_{TS}) is measured using the ISO 13837 standard.

The color variables L*, a*, and b* of the color system CIELAB 1976 are also calculated through the tristimulus values.

The glass may be melted and refined in a continuous, large-scale commercial glass melting operation. It may further be formed into flat glass sheets of varying thickness by the float method in which the molten glass is supported on a pool of molten metal, usually tin, as it assumes a ribbon shape and is cooled in a manner well known in the art.

As shown in Table 1, below, the following formulations represent non-limiting embodiments of the presently described glass. All examples demonstrate that the amount of titanium oxide (TiO₂) present as impurities is less than 0.02 percent. Examples 1-8 were produced using an electric furnace, while Examples 9-19 were produced using a gas furnace.

TABLE 1
Composition

| | Examples | | | | | | |
|---|---|---|---|---|---|---|---|
| By weight | 1 | 2 | 3 | 4 | 5 | 6 | 7 |
| Fe₂O₃ (%) | 0.304 | 0.309 | 0.306 | 0.312 | 0.507 | 0.513 | 0.509 |
| Redox FeO/Fe₂O₃ | 0.706 | 0.711 | 0.751 | 0.740 | 0.660 | 0.701 | 0.694 |
| FeO (%) | 0.215 | 0.220 | 0.230 | 0.231 | 0.335 | 0.360 | 0.353 |
| SO₃ (%) | 0.046 | 0.048 | 0.051 | 0.046 | 0.050 | 0.051 | 0.054 |
| CoO (ppm) | 277 | 396 | 468 | 551 | 346 | 367 | 378 |
| TiO₂ (%) | 0.017 | 0.018 | 0.018 | 0.018 | 0.017 | 0.018 | 0.018 |
| Cr₂O₃ (ppm) | 1.8 | 2.0 | 2.1 | 2.1 | 1.6 | 0.0 | 2.0 |
| | Examples | | | | | | |
| By weight | 8 | 9 | 10 | 11 | 12 | 13 | 14 |
| Fe₂O₃ (%) | 0.516 | 0.574 | 0.572 | 0.599 | 0.501 | 0.524 | 0.496 |
| Redox FeO/Fe₂O₃ | 0.707 | 0.807 | 0.805 | 0.819 | 0.768 | 0.751 | 0.757 |
| FeO (%) | 0.365 | 0.463 | 0.460 | 0.491 | 0.385 | 0.393 | 0.376 |
| SO₃ (%) | 0.056 | 0.075 | 0.080 | 0.078 | 0.055 | 0.050 | 0.045 |
| CoO (ppm) | 399 | 351 | 387 | 426 | 348 | 398 | 403 |
| TiO₂ (%) | 0.018 | 0.059 | 0.059 | 0.057 | 0.054 | 0.055 | 0.055 |
| Cr₂O₃ (ppm) | 2.2 | 8.3 | 8.4 | 8.9 | 5.8 | 8.1 | 8.2 |

| | Examples | | | | |
|---|---|---|---|---|---|
| By weight | 15 | 16 | 17 | 18 | 19 |
| Fe₂O₃ (%) | 0.489 | 0.460 | 0.495 | 0.473 | 0.507 |
| Redox FeO/Fe₂O₃ | 0.754 | 0.731 | 0.696 | 0.707 | 0.633 |
| FeO (%) | 0.369 | 0.337 | 0.345 | 0.335 | 0.321 |
| SO₃ (%) | 0.045 | 0.044 | 0.050 | 0.056 | 0.067 |
| CoO (ppm) | 424 | 361 | 387 | 387 | 399 |
| TiO₂ (%) | 0.057 | 0.062 | 0.064 | 0.061 | 0.061 |
| Cr₂O₃ (ppm) | 7.4 | 10.8 | 10.2 | 9.1 | 8.4 |

The following non-limiting formulations in Table 2 represent basic batch components, colorants, and redox agents to produce 1 ton of glass. The amount of coal added to the glass batch may be deliberately varied over the examples: 0.10 weight percent coal is added to the batch in Examples 1-4, 0.05 weight percent coal is added to the batch in Examples 5-8, 0.021 weight percent is added to the batch in Examples 9-11, while 0.019 weight percent coal is added to the batch in Examples 12-19. Again, Examples 1-8 were produced using an electric furnace, while Examples 9-19 were produced using a gas furnace.

TABLE 2
Batch Chemistry

| | Examples | | | | | | |
|---|---|---|---|---|---|---|---|
| | 1 | 2 | 3 | 4 | 5 | 6 | 7 |
| Coal (%) | 0.10 | 0.10 | 0.10 | 0.10 | 0.05 | 0.05 | 0.05 |
| Pyrite, FeS₂ (%) | 0.13 | 0.15 | 0.17 | 0.19 | 0.35 | 0.35 | 0.35 |
| S (%) from Pyrite | 0.07 | 0.08 | 0.09 | 0.10 | 0.18 | 0.18 | 0.18 |
| | Examples | | | | | | |
| | 8 | 9 | 10 | 11 | 12 | 13 | 14 |
| Coal (%) | 0.05 | 0.021 | 0.021 | 0.021 | 0.019 | 0.019 | 0.019 |
| Pyrite, FeS₂ (%) | 0.35 | 0.35 | 0.35 | 0.35 | 0.18 | 0.18 | 0.18 |
| S (%) from Pyrite | 0.18 | 0.18 | 0.18 | 0.18 | 0.09 | 0.09 | 0.09 |

| | Examples | | | | |
|---|---|---|---|---|---|
| | 15 | 16 | 17 | 18 | 19 |
| Coal (%) | 0.019 | 0.019 | 0.019 | 0.019 | 0.019 |
| Pyrite, FeS₂ (%) | 0.18 | 0.18 | 0.16 | 0.14 | 0.12 |
| S (%) from Pyrite | 0.09 | 0.09 | 0.08 | 0.07 | 0.06 |

The following are non-limiting examples of the glass compositions presented in Tables 1 and 2, reporting the physical properties of light transmission at a control thickness of 4.10 mm. Table 3 reports values associated with various forms of light transmittance as described in detail above. Table 4 reports color transmittance values associated with glass color, in terms of dominant wavelength and excitation purity, measured using CIE standard illuminant “D65” with a 10° observer following the procedures established in ASTM E308.

TABLE 3
Solar Properties

| | Examples | | | | | | |
|---|---|---|---|---|---|---|---|
| | 1 | 2 | 3 | 4 | 5 | 6 | 7 |
| Solar UV Transmittance (T_{UV}) | 2.5 | 5.2 | 0.5 | 0.6 | 14.0 | 2.8 | 2.6 |
| Visible Light Transmittance | 17.6 | 13.6 | 7.1 | 5.6 | 17.5 | 12.2 | 11.7 |
| Iluminant A (T_{LA}) | | | | | | | |
| Solar Direct Transmittance (Te) | 19.3 | 18.0 | 14.0 | 13.4 | 15.3 | 10.6 | 10.6 |
| Infrared Transmittance (T_{IR}) | 22.9 | 21.6 | 19.8 | 19.3 | 11.6 | 10.2 | 10.4 |
| Total Solar Transmittance (T_{TS}) | 40.1 | 39.1 | 36.3 | 35.8 | 37.2 | 33.8 | 33.8 |
| | Examples | | | | | | |
| | 8 | 9 | 10 | 11 | 12 | 13 | 14 |
| Solar UV Transmittance (T_{UV}) | 2.5 | 0.0 | 0.0 | 0.0 | 0.0 | 0.0 | 0.1 |
| Visible Light Transmittance | 10.8 | 0.8 | 0.7 | 0.7 | 5.6 | 5.2 | 6.6 |
| Iluminant A (T_{LA}) | | | | | | | |
| Solar Direct Transmittance (Te) | 9.9 | 3.5 | 3.4 | 3.0 | 7.1 | 6.7 | 7.7 |
| Infrared Transmittance (T_{IR}) | 9.8 | 6.2 | 6.1 | 5.3 | 9.1 | 8.5 | 9.3 |
| Total Solar Transmittance (T_{TS}) | 33.3 | 28.6 | 28.6 | 28.3 | 31.2 | 30.9 | 31.7 |

| | Examples | | | | |
|---|---|---|---|---|---|
| | 15 | 16 | 17 | 18 | 19 |
| Solar UV Transmittance (T_{UV}) | 0.3 | 3.2 | 11.8 | 14.5 | 46.7 |
| Visible Light Transmittance | 7.3 | 14.0 | 16.4 | 17.1 | 20.6 |
| Iluminant A (T_{LA}) | | | | | |
| Solar Direct Transmittance (Te) | 8.1 | 12.1 | 14.3 | 15.5 | 23.4 |
| Infrared Transmittance (T_{IR}) | 9.6 | 11.7 | 11.2 | 11.9 | 12.7 |
| Total Solar Transmittance (T_{TS}) | 32.0 | 34.9 | 36.5 | 37.3 | 43.1 |

TABLE 4
Color Transmitted Iluminant D65 10° Obs (ASTM E308)

| | Examples | | | | | | |
|---|---|---|---|---|---|---|---|
| | 1 | 2 | 3 | 4 | 5 | 6 | 7 |
| X | 14.4 | 11.0 | 5.6 | 4.3 | 15.3 | 9.7 | 9.3 |
| Y | 16.3 | 13.5 | 6.5 | 5.2 | 18.9 | 12.0 | 11.5 |
| Z | 4.6 | 7.8 | 1.2 | 1.2 | 20.6 | 5.3 | 4.9 |
| L* | 47.3 | 43.5 | 30.5 | 27.3 | 50.5 | 41.2 | 40.4 |
| a* | −6.3 | −12.3 | −5.7 | −7.7 | −14.7 | −12.8 | −12.5 |
| b* | 39.5 | 19.2 | 35.7 | 29.5 | −0.7 | 25.3 | 25.5 |
| Dominant | 567.4 | 557.9 | 567.1 | 564.8 | 490.1 | 560.2 | 560.5 |
| Wavelength (nm) | | | | | | | |
| Purity (%) | 63.6 | 32.3 | 74.8 | 67.7 | 11.9 | 44.7 | 45.9 |
| | Examples | | | | | | |
| | 8 | 9 | 10 | 11 | 12 | 13 | 14 |
| X | 8.5 | 0.8 | 0.7 | 0.7 | 4.8 | 4.3 | 5.4 |
| Y | 10.6 | 0.6 | 0.5 | 0.5 | 4.7 | 4.4 | 5.8 |
| Z | 4.7 | 0.0 | 0.0 | 0.0 | 0.1 | 0.2 | 0.5 |
| L* | 38.9 | 5.4 | 4.4 | 4.8 | 25.7 | 24.8 | 28.9 |
| a* | −13.0 | 9.2 | 7.9 | 7.4 | 5.4 | 2.5 | −1.1 |
| b* | 24.0 | 9.3 | 7.6 | 8.2 | 49.9 | 46.3 | 44.9 |
| Dominant | 559.4 | 585.8 | 586.5 | 584.5 | 576.2 | 574.5 | 570.7 |
| Wavelength (nm) | | | | | | | |
| Purity (%) | 44.1 | 99.7 | 99.4 | 99.6 | 95.8 | 94.0 | 88.9 |

| | Examples | | | | |
|---|---|---|---|---|---|
| | 15 | 16 | 17 | 18 | 19 |
| X | 5.8 | 11.2 | 14.3 | 15.3 | 24.0 |
| Y | 6.6 | 13.8 | 17.7 | 18.7 | 25.6 |
| Z | 1.0 | 6.5 | 19.0 | 22.9 | 63.9 |
| L* | 31.0 | 43.9 | 49.2 | 50.4 | 57.7 |
| a* | −5.4 | −12.8 | −14.5 | −13.9 | −1.4 |
| b* | 39.0 | 24.8 | 0.1 | −5.1 | −41.2 |
| Dominant | 567.5 | 560.1 | 491.5 | 484.5 | 471.3 |
| Wavelength (nm) | | | | | |
| Purity (%) | 79.2 | 41.9 | 11.1 | 17.1 | 50.4 |

Regarding the various data presented in the above tables the following noted are pertinent Tuv, ISO 13837, air mass 1.5 300 a 400 nm; Te, ISO 13837 air mass 1.5 300 a 2500 nm; T_{IR}, ISO 13837 air mass 1.5 800 a 2500 nm; T_{TS}, ISO 13837, v=4 m/seg; and T_{LA} CIE standard Ilum “A” 380 a 780 nm.

It should be noted that in any of the Examples contained herein, the coal in the batch chemistry can be replaced at a one to one ratio with any other suitable alternative source of carbon including, but not limited to, graphite. Should this change be made, no other changes need to be made to the batch chemistry in any of the above noted Examples. Additionally, should an electric furnace be used to process the batch chemistry, the amount of coal, or other carbon source, should be varied accordingly in light of the different processing environment present in an electric furnace to that of a gas furnace. In one non-limiting example, since the coal, or other carbon source, is considered a reducing agent, the amount of carbon used should be varied based on the nature of the atmospheric makeup and/or environment present in the furnace used to process a desired glass batch in accordance with any of the embodiments of the invention.

As is known in the art, glass recycling is an integral part of various types of glass production. As such, in some cases the present invention may make use of one or more sources of glass cullet (i.e., recycled glass material). As is known, there are two types of cullet: internal and external. Internal cullet is composed of defective products detected and rejected by a quality control process during the industrial process of glass manufacturing, transition phases of product changes (such as thickness and color changes) and production offcuts, while external cullet is waste glass that has been collected or reprocessed with the purpose of recycling. External cullet, which can be pre-or post-consumer, may be classified as waste. In some embodiments, the present invention can make use of any suitable type of cullet, be it internal or external cullet. Should a large amount of external cullet be added to any of the batch chemistries detailed above, the amount of Fe₂S additive should be adjusted accordingly, if such external cullet is composed of more than 50 weight percent visually clear glass as opposed to glass that appears either visually green, or blue green.

Accordingly, in light of the above, in one embodiment of the invention, a glass composition comprises: 66-75 weight percent SiO₂; 10-20 weight percent Na₂O; 5-15 weight percent CaO; 0-5 weight percent MgO; 0-5 weight percent Al₂O₃; 0-3 weight percent K₂O; 0.042-0.082 weight percent SO₃; and 0.292-0.611 weight percent total iron expressed as Fe₂O₃, wherein the glass is substantially free of Se, and wherein the glass has a T_{LA} of greater than 0 percent and equal to or less than 21 percent at a glass thickness of 4.1 mm as CIE standard Ilum “A” wavelengths 380 nm to 780 nm. In one instance, the glass of the present invention has a redox ratio of at least 0.617 and at most 0.835, or even a redox ratio of at least 0.633 and at most 0.819. In still another instance, the glass further comprises 0.0265-0.0563 weight percent CoO, or even 0.0277-0.0551 weight percent CoO. In still another instance, the glass comprises 0.205-0.501 weight percent FeO. In still another instance, the glass is substantially free of SnO₂. In still another instance, the glass has a T_{UV} of less than 47, less than 20, or even less than 10 and/or a Te of less than 23, less than 20, or even less than 16.

Accordingly, in light of the above, in one embodiment of the invention, a method of making a glass using a conventional float non-vacuum glass system, comprises: melting a glass batch to provide a pool of molten glass; flowing the pool of molten glass onto the molten tin bath; moving the molten glass on the surface of the molten tin bath, while controllably cooling the molten glass and applying forces to the molten glass to provide a glass of a desired thickness; and removing the glass from the molten tin bath, wherein the glass comprises: 66-75 weight percent SiO₂; 10-20 weight percent Na₂O; 5-15 weight percent CaO; 0-5 weight percent MgO; 0-5 weight percent Al₂O₃; 0-3 weight percent K₂O; 0.042-0.082 weight percent SO₃; and 0.292-0.611 weight percent total iron expressed as Fe₂O₃, wherein the glass is substantially free of Se, and wherein the glass has a T_{LA} of greater than 0 percent and equal to or less than 21 percent at a glass thickness of 4.1 mm as CIE standard Ilum “A” wavelengths 380 nm to 780 nm. In one instance, the glass has a redox ratio of at least 0.617 and at most 0.835, or even a redox ratio of at least 0.633 and at most 0.819. In still another instance, the glass further comprises 0.0265-0.0563 weight percent CoO, or even 0.0277-0.0551 weight percent CoO. In still another instance, the glass comprises 0.205-0.501 weight percent FeO. In one instance the method of this embodiment utilizes a glass batch that comprises 0.017-0.102 weight percent coal. In another instance, the method of this embodiment utilizes a glass batch that comprises 0.112-0.361 weight percent Fe₂S. In still another instance, the glass batch, or the glass itself, is substantially free of SnO₂. In still another instance, the glass of this method has a T_{UV} of less than 47, less than 20, or even less than 10 and/or a Te of less than 23, less than 20, or even less than 16.

Accordingly, in light of the above, in another embodiment of the invention, a glass comprising: 66-75 weight percent SiO₂; 10-20 weight percent Na₂O; 5-15 weight percent CaO; 0-5 weight percent MgO; 0-5 weight percent Al₂O₃; 0-3 weight percent K₂O; 0.043-0.081 weight percent SO₃; and 0.298-0.605 weight percent total iron expressed as Fe₂O₃, wherein the glass is substantially free of Se, and wherein the glass has a T_{LA} of greater than 0 percent and equal to or less than 21 percent at a glass thickness of 4.1 mm as CIE standard Ilum “A” wavelengths 380 nm to 780 nm. In one instance, the glass of the present invention has a redox ratio of at least 0.625 and at most 0.827, or even a redox ratio of at least 0.633 and at most 0.819. In still another instance, the glass further comprises 0.0271-0.0557 weight percent CoO, or even 0.0277-0.0551 weight percent CoO. In still another instance, the glass comprises 0.210-0.496 weight percent FeO. In still another instance, the glass is substantially free of SnO₂. In still another instance, the glass has a T_{UV} of less than 47, less than 20, or even less than 10 and/or a Te of less than 23, less than 20, or even less than 16.

Accordingly, in light of the above, in another embodiment of the invention, a method of making a glass using a conventional float non-vacuum glass system, comprising: melting a glass batch to provide a pool of molten glass; flowing the pool of molten glass onto the molten tin bath; moving the molten glass on the surface of the molten tin bath, while controllably cooling the molten glass and applying forces to the molten glass to provide a glass of a desired thickness; and removing the glass from the molten tin bath, wherein the glass comprises: 66-75 weight percent SiO₂; 10-20 weight percent Na₂O; 5-15 weight percent CaO; 0-5 weight percent MgO; 0-5 weight percent Al₂O₃; 0-3 weight percent K₂O; 0.043-0.081 weight percent SO₃; and 0.298-0.605 weight percent total iron expressed as Fe₂O₃, wherein the glass is substantially free of Se, and wherein the glass has a T_{LA} of greater than 0 percent and equal to or less than 21 percent at a glass thickness of 4.1 mm as CIE standard Ilum “A” wavelengths 380 nm to 780 nm. In one instance, the glass has a redox ratio of at least 0.625 and at most 0.827, or even a redox ratio of at least 0.633 and at most 0.819. In still another instance, the glass further comprises 0.0271-0.0557 weight percent CoO, or even 0.0277-0.0551 weight percent CoO. In still another instance, the glass comprises 0.210-0.496 weight percent FeO. In one instance the method of this embodiment utilizes a glass batch that comprises 0.018-0.101 weight percent coal. In another instance, the method of this embodiment utilizes a glass batch that comprises 0.116-0.357 weight percent Fe₂S. In still another instance, the glass batch, or the glass itself, is substantially free of SnO₂. In still another instance, the glass of this method has a T_{UV} of less than 47, less than 20, or even less than 10 and/or a Te of less than 23, less than 20, or even less than 16.

Accordingly, in light of the above, in another embodiment of the invention, a glass comprising: 66-75 weight percent SiO₂; 10-20 weight percent Na₂O; 5-15 weight percent CaO; 0-5 weight percent MgO; 0-5 weight percent Al₂O₃; 0-3 weight percent K₂O; 0.044-0.080 weight percent SO₃; and 0.304-0.599 weight percent total iron expressed as Fe₂O₃, wherein the glass is substantially free of Se, and wherein the glass has a T_{LA} of greater than 0 percent and equal to or less than 21 percent at a glass thickness of 4.1 mm as CIE standard Ilum “A” wavelengths 380 nm to 780 nm. In one instance, the glass of the present invention has a redox ratio of at least 0.633 and at most 0.819. In still another instance, the glass further comprises 0.0277-0.0551 weight percent CoO. In still another instance, the glass comprises 0.215-0.491 weight percent FeO. In still another instance, the glass is substantially free of SnO₂. In still another instance, the glass has a T_{UV} of less than 47, less than 20, or even less than 10 and/or a Te of less than 23, less than 20, or even less than 16.

In still another embodiment, any of the glasses of the present invention further comprise 0.0158-0.0652 weight percent TiO₂, or 0.0164-0.0646 weight percent TiO₂, or even 0.0170-0.0640 weight percent TiO₂. Furthermore, any of the glass compositions of the present invention further comprise 0-0.0013 weight percent Cr₂O₃, or 0-0.0012 weight percent weight percent Cr₂O₃, or even 0-0.0011 weight percent Cr₂O₃.

Accordingly, in light of the above, in another embodiment of the invention, a method of making a glass using a conventional float non-vacuum glass system, comprising: melting a glass batch to provide a pool of molten glass; flowing the pool of molten glass onto the molten tin bath; moving the molten glass on the surface of the molten tin bath, while controllably cooling the molten glass and applying forces to the molten glass to provide a glass of a desired thickness; and removing the glass from the molten tin bath, wherein the glass comprises: 66-75 weight percent SiO₂; 10-20 weight percent Na₂O; 5-15 weight percent CaO; 0-5 weight percent MgO; 0-5 weight percent Al₂O₃; 0-3 weight percent K₂O; 0.044-0.080 weight percent SO₃; and 0.304-0.599 weight percent total iron expressed as Fe₂O₃, wherein the glass is substantially free of Se, and wherein the glass has a T_{LA} of greater than 0 percent and equal to or less than 21 percent at a glass thickness of 4.1 mm as CIE standard Ilum “A” wavelengths 380 nm to 780 nm. In one instance, the glass has a redox ratio of at least 0.633 and at most 0.819. In still another instance, the glass further comprises 0.0277-0.0551 weight percent CoO. In still another instance, the glass comprises 0.215-0.491 weight percent FeO. In one instance the method of this embodiment utilizes a glass batch that comprises 0.019-0.1 weight percent coal. In another instance, the method of this embodiment utilizes a glass batch that comprises 0.12-0.353 weight percent Fe₂S. In still another instance, the glass batch, or the glass itself, is substantially free of SnO₂. In still another instance, the glass of this method has a T_{UV} of less than 47, less than 20, or even less than 10 and/or a Te of less than 23, less than 20, or even less than 16.

In still another embodiment, any of the methods of making a glass using a conventional float non-vacuum glass system comprises 0.0158-0.0652 weight percent TiO₂, or 0.0164-0.0646 weight percent TiO₂, or even 0.0170-0.0640 weight percent TiO₂. Furthermore, any of the methods of making a glass using a conventional float non-vacuum glass system comprises 0-0.0013 weight percent Cr₂O₃, or 0-0.0012 weight percent weight percent Cr₂O₃, or even 0-0.0011 weight percent Cr₂O₃.

Regarding any numerical values disclosed in the specification, be the individual values in one or more examples or from one or more portions of a numerical range, any of these individual numerical values can be combined with any other numerical value of a similar nature. That is, any individual redox numerical value can be combined with any other different redox numerical value to yield a new non-disclosed redox numerical range. Further, any individual numerical value from a given composition component, a given batch component, a given solar property, or even a given color property can be combined with any other different respective numerical value from a given composition component, a given batch component, a given solar property, or even a given color property to yield a new non-disclosed numerical range for one or more of a given composition component, a given batch component, a given solar property, or even a given color property.

Reaching the proposed properties for a selenium-free privacy glass composition, according to the scope of the invention, other variations may be applied without departing from what is described in the claims that follow. Accordingly, the particular embodiments described in detail herein are illustrative only and are not limiting as to the scope of the invention, which is to be given the full breadth of the appended claims and any and all equivalents thereof.

1. A glass comprising:

| | | |
|---|---|---|
| SiO₂ | 66-75 | weight percent; |
| Na₂O | 10-20 | weight percent; |
| CaO | 5-15 | weight percent; |
| MgO | 0-5 | weight percent; |
| Al₂O₃ | 0-5 | weight percent; |
| K₂O | 0-3 | weight percent; |
| SO₃ | 0.04-0.09 | weight percent; and |
| total iron as Fe₂O₃ | 0.29-0.62 | weight percent, |

wherein the glass is substantially free of Se, and wherein the glass has a visible light transmission (“T_{LA}”) of greater than 0 percent and equal to or less than 21 percent at a glass thickness of 4.1 mm as CIE standard Ilum “A” wavelengths 380 nm to 780 nm.

2. The glass of claim 1, further comprising a redox ratio of at least 0.61 and at most 0.84.

3. The glass of claim 1, further comprising 0.026-0.057 weight percent CoO.

4. The glass of claim 1, further comprising 0.20-0.51 weight percent FeO.

5. The glass of claim 1, wherein the glass is substantially free of SnO₂.

6. The glass of claim 1, wherein the glass has a T_{UV} of less than 47.

7. The glass of claim 1, wherein the glass has a Te of less than 23.

8. A glass comprising:

| | | |
|---|---|---|
| SiO₂ | 66-75 | weight percent; |
| Na₂O | 10-20 | weight percent; |
| CaO | 5-15 | weight percent; |
| MgO | 0-5 | weight percent; |
| Al₂O₃ | 0-5 | weight percent; |
| K₂O | 0-3 | weight percent; |
| SO₃ | 0.042-0.082 | weight percent; and |
| total iron as Fe₂O₃ | 0.29-0.62 | weight percent, |

wherein the glass is substantially free of Se, and wherein the glass has a T_{LA} of greater than 0 percent and equal to or less than 21 percent at a glass thickness of 4.1 mm as CIE standard Ilum “A” wavelengths 380 nm to 780 nm.

9. The glass of claim 8, further comprising a redox ratio of at least 0.61 and at most 0.84.

10. The glass of claim 8, further comprising 0.026-0.057 weight percent CoO.

11. The glass of claim 8, further comprising 0.20-0.51 weight percent FeO.

12. The glass of claim 8, wherein the glass is substantially free of SnO₂.

13. The glass of claim 8, wherein the glass has a T_{UV} of less than 47.

14. The glass of claim 8, wherein the glass has a Te of less than 23.

15. A method of making a glass using a conventional float non-vacuum glass system, comprising:
melting a glass batch to provide a pool of molten glass;
flowing the pool of molten glass onto the molten tin bath;
moving the molten glass on the surface of the molten tin bath, while controllably cooling the molten glass and applying forces to the molten glass to provide a glass of a desired thickness; and
removing the glass from the molten tin bath, wherein the glass comprises:

| | | |
|---|---|---|
| SiO₂ | 66-75 | weight percent; |
| Na₂O | 10-20 | weight percent; |
| CaO | 5-15 | weight percent; |
| MgO | 0-5 | weight percent; |
| Al₂O₃ | 0-5 | weight percent; |
| K₂O | 0-3 | weight percent; |
| SO₃ | 0.042-0.082 | weight percent; and |
| total iron as Fe₂O₃ | 0.29-0.62 | weight percent; |

wherein the glass is substantially free of SnO₂, and
wherein the glass has a visible light transmission (“T_{LA}”) of greater than 0 percent and equal to or less than 21 percent at a glass thickness of 4.1 mm as CIE standard Ilum “A” wavelengths 380 nm to 780 nm.

16. The method of claim 15, wherein the glass further comprises a redox ratio of at least 0.61 and at most 0.84.

17. The method of claim 15, wherein the glass further comprises 0.026-0.057 weight percent CoO.

18. The method of claim 15, wherein the glass further comprises 0.20-0.51 weight percent FeO.

19. The method of claim 15, wherein the glass batch, or the glass composition, is substantially free of SnO₂.

20. The method of claim 15, wherein the glass has a T_{UV} of less than 47.
